(19) United States
(12) Patent Application Publication
(10) Pub. No.: US 2022/0020319 A1
(43) Pub. Date: Jan. 20, 2022

(54) DISPLAY APPARATUS AND OPERATION METHOD THEREOF

(71) Applicant: LG ELECTRONICS INC., Seoul (KR)

(72) Inventor: Kihun LEE, Seoul (KR)

(73) Assignee: LG ELECTRONICS INC., Seoul (KR)

(21) Appl. No.: 17/413,316

(22) PCT Filed: Aug. 27, 2019
(86) PCT No.: PCT/KR2019/010928

§ 371 Date: Jun. 11, 2021

(51) Int. Cl. G09G 3/3208

(52) U.S. Cl. CPC G09G 3/3208; G09G 2320/043; G09G 2300/0842; G09G 2310/08; G09G 2320/0686

(57) ABSTRACT

The purpose of the present invention is to minimize the shortening of the lifespan of a pixel while maintaining the luminance of an image, and the present invention comprises: a display unit including a plurality of pixels; and a control unit for controlling the plurality of pixels according to pixel data of an input image, wherein the control unit may acquire a block of similar color in an area where an image is output by the display unit and adjust the luminance of at least one of the pixels belonging to the block to be low.

### TECHNICAL FIELD

The present invention relates to a display device and operating method thereof, and more particularly, to an organic light emitting diode display device.

### BACKGROUND ART

In recent years, the types of display devices have been diversified. Among them, an organic light emitting diode (OLED) display device is widely used.

Since the OLED display device is a self-luminous device, the OLED display device has lower power consumption and can be made thinner than a liquid crystal display (LCD) requiring a backlight. In addition, the OLED display device has a wide viewing angle and a fast response time.

On the other hand, an organic light emitting device has a relatively short lifespan. In particular, when the organic light emitting device continuously emits light with the same color, there is a problem that the lifespan is shortened because the organic light emitting device is burned-in.

As one of conventional methods for solving the problem of shortening the lifespan, there is a method of extracting an area (e.g., a logo area) in which the same image is continuously displayed and then lowering the brightness of the extracted area. However, according to the conventional method, it is difficult to accurately determine an area in which the same image is continuously displayed and there are problems that a user perceives that the brightness of a specific area such as a logo area is suddenly decreased and it is difficult to apply the conventional method to a still image.

### DISCLOSURE

### Technical Problem

An object of the present disclosure is to provide a display device for minimizing a reduction in the lifetime of a pixel while maintaining the brightness of an image and a method for operating the same.

An object of the present disclosure is to provide a display device and a method for operating the same, which minimize a reduction in the lifespan of a pixel, regardless of whether a playback image is a still image or a video image.

An object of the present disclosure is to provide a display device and a method for operating the same, which minimize a reduction in the lifespan of a pixel, regardless of whether pixel element arrangement is an RGB method or a WRGB method.

### Technical Solution

According to an embodiment, a display device includes a display including a plurality of pixels, and a controller configured to control the plurality of pixels according to pixel data of an input image, wherein the controller is configured to obtain a block having similar colors among regions in which an image is output by the display, and perform adjustment to decrease a brightness of at least one of the pixels belonging to the block.

The controller may obtain the block having similar colors based on pixel data for each frame.

The controller may recognize a first pixel and a second pixel as having the similar colors when a difference between pixel data of the first pixel and pixel data of the second pixel adjacent to the first pixel is less than or equal to a preset reference value.

The controller may obtain the block by extracting pixels whose a difference between pixel data is less than or equal to a preset reference value.

The controller may divide pixels belonging to the block into a first group and a second group, and perform adjustment to decrease a brightness of one of the first group and the second group.

The controller may divide the pixels belonging to the block into the first group and the second group such that pixels belonging to the first group and pixels belonging to the second group are alternately arranged.

The controller may perform adjustment to alternately decrease a brightness of the pixels belonging to the first group and a brightness of the pixels belonging to the second group.

The controller may alternately perform a first mode and a second mode every set period. The first mode may be a mode in which the pixels belonging to the first group are driven according to pixel data, and the pixels belonging to the second group are driven at a lower brightness than the pixel data, and the second mode may be a mode in which the pixels belonging to the second group are driven according to the pixel data, and the pixels belonging to the first group are driven with a lower brightness than the pixel data.

The controller may perform adjustment to decrease a brightness of at least one of the pixels belonging to the block when a size of the block is greater than or equal to a reference size.

The controller may obtain the size of the block based on the number of pixels belonging to the block.

The controller may control brightness of the pixels belonging to the block according to the pixel data when the size of the block is less than the reference size.

The controller may obtain a plurality of blocks in a single frame.

The controller may change a position of block, a size of a block, or the number of blocks according to s frame.

The controller may periodically change a pixel having a brightness to be decreased among pixels belonging to the block.

According to an embodiment of the present disclosure, a method for operating a display device include receiving an image, obtaining a block having similar colors based on pixel data of the image, and decreasing a brightness of at least one of the pixels belonging to the block.

### Advantageous Effects

According to an embodiment of the present disclosure, there is an advantage of minimizing a decrease in brightness of an image felt by a user while minimizing a reduction in the lifetime of a pixel.

Specifically, by controlling the brightness of some of the pixels expressing similar colors to be decreased, it is possible to minimize a case in which a user perceives a decrease in brightness while minimizing continuous light emission of the pixels and shorten the lifespan of the pixels.

In addition, even when a playback image is a video image as well as a still image, it is possible to minimize a reduction in the lifetime of a pixel while maintaining brightness.

In addition, even when the pixel element arrangement method (element type) of the pixel is the WRGB method as well as the RGB method, it is possible to minimize the reduction in the lifetime of the pixel while maintaining brightness.

In addition, when the size of a block composed of similar colors is smaller than a reference size, a decrease in brightness of an image perceived by a user can be minimized by controlling a pixel according to pixel data.

In addition, since the brightness of some pixels is lowered, power consumption can also be reduced.

### DESCRIPTION OF DRAWINGS

FIG. 1 is a diagram illustrating a display device according to an embodiment of the present invention.

FIG. 2 is an example of a block diagram of the inside of the display device in FIG. 1.

FIG. 3 is an example of a block diagram of the inside of a controller in FIG. 2.

FIG. 4A is a diagram illustrating a method in which the remote controller in FIG. 2 performs control.

FIG. 4B is a block diagram of the inside of the remote controller in FIG. 2.

FIG. 5 is a block diagram of the inside of the display in FIG. 2.

FIGS. 6A and 6B are diagrams that are referred to for description of the OLED panel in FIG. 5.

FIG. 7 is a flowchart for a method for operating a display device according to a first embodiment of the present disclosure.

FIG. 8 is a flowchart for a method for operating a display device according to a second embodiment of the present disclosure.

FIGS. 9 to 10 are exemplary diagrams for describing a method for obtaining a block having similar colors in a display device according to an embodiment of the present disclosure.

FIG. 11 is a flowchart for an embodiment of a method for lowering a brightness of at least one of pixels belonging to a block in a display device according to an embodiment of the present disclosure.

FIG. 12 is an exemplary diagram showing a method for dividing pixels belonging to a specific block into a first group and a second group in a display device according to an embodiment of the present disclosure.

FIG. 13 is an exemplary diagram for describing a method for controlling the brightness of pixels belonging to a first group and pixels belonging to a second group in a display device according to an embodiment of the present disclosure.

### MODE FOR INVENTION

Hereinafter, the present invention will be described in detail with reference to the drawings.

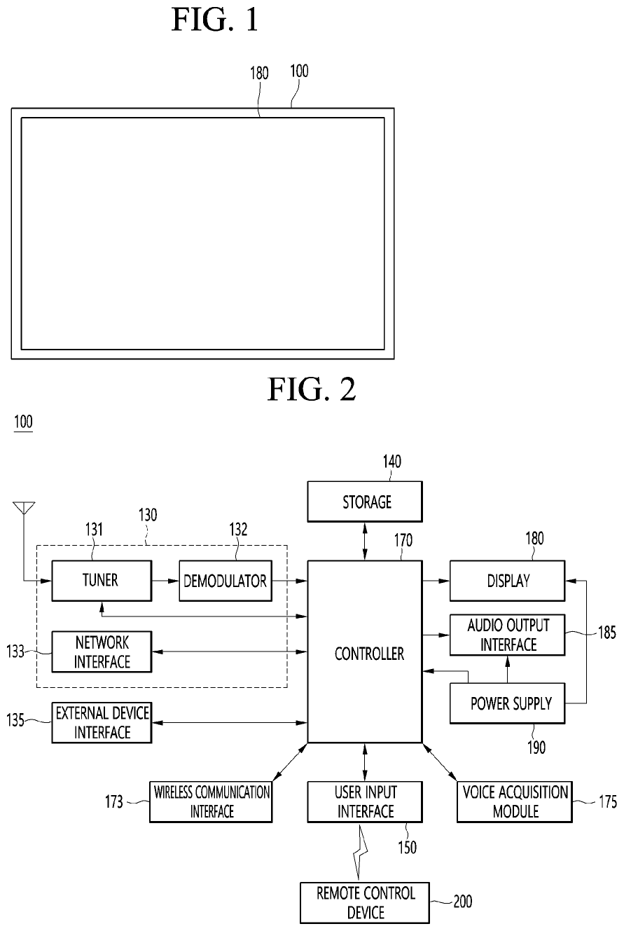

FIG. 1 is a diagram illustrating a display device according to an embodiment of the present invention.

With reference to the drawings, a display device 100 includes a display 180.

On the other hand, the display 180 is realized by one among various panels. For example, the display 180 is one of the following panels: a liquid crystal display panel (LCD panel), an organic light-emitting diode (OLED) panel (OLED panel), and an inorganic light-emitting diode (OLED) panel (ILED panel).

According to the present invention, the display 180 is assumed to include an organic light-emitting diode (OLED) panel (OLED). It should be noted that this is only exemplary, and the display unit 180 may include a panel other than an organic light emitting diode panel (OLED panel).

On the other hand, examples of the display device 100 in FIG. 1 include a monitor, a TV, a tablet PC, a mobile terminal, and so on.

FIG. 2 is an example of a block diagram of the inside of the display device in FIG. 1.

With reference to FIG. 2, a display device 100 can include a broadcast reception module 130, an external device interface 135, a storage 140, a user input interface 150, a controller 170, a wireless communication interface 173, a voice acquisition module 175, a display 180, an audio output interface 185, and a power supply 190.

The broadcast reception module 130 can include a tuner 131, a demodulator 132, and a network interface 133.

The tuner 131 can select a specific broadcast channel according to a channel selection command. The tuner 131 can receive broadcast signals for the selected specific broadcast channel.

The demodulator 132 can divide the received broadcast signals into video signals, audio signals, and broadcast program related data signals and restore the divided video signals, audio signals, and data signals to an output available form.

The network interface 133 can provide an interface for connecting the display device 100 to a wired/wireless network including internet network. The network interface 133 can transmit or receive data to or from another user or another electronic device through an accessed network or another network linked to the accessed network.

The network interface 133 can access a predetermined webpage through an accessed network or another network linked to the accessed network. That is, it can transmit or receive data to or from a corresponding server by accessing a predetermined webpage through network.

Then, the network interface 133 can receive contents or data provided from a content provider or a network operator. That is, the network interface 133 can receive contents such as movies, advertisements, games, VODs, and broadcast signals, which are provided from a content provider or a network provider, through network and information relating thereto.

Additionally, the network interface 133 can receive firmware update information and update files provided from a network operator and transmit data to an internet or content provider or a network operator.

The network interface 133 can select and receive a desired application among applications open to the air, through network.

The external device interface 135 can receive an application or an application list in an adjacent external device and deliver it to the controller 170 or the storage 140.

The external device interface 135 can provide a connection path between the display device 100 and an external device. The external device interface 135 can receive at least one of image and audio outputted from an external device that is wirelessly or wiredly connected to the display device 100 and deliver it to the controller. The external device interface 135 can include a plurality of external input terminals. The plurality of external input terminals can include an RGB terminal, at least one High Definition Multimedia Interface (HDMI) terminal, and a component terminal.

An image signal of an external device inputted through the external device interface 135 can be outputted through the display 180. A sound signal of an external device inputted through the external device interface 135 can be outputted through the audio output interface 185.

An external device connectable to the external device interface 135 can be one of a set-top box, a Blu-ray player, a DVD player, a game console, a sound bar, a smartphone, a PC, a USB Memory, and a home theater system but this is just exemplary.

Additionally, some content data stored in the display device 100 can be transmitted to a user or an electronic device, which is selected from other users or other electronic devices pre-registered in the display device 100.

The storage 140 can store signal-processed image, voice, or data signals stored by a program in order for each signal processing and control in the controller 170.

Additionally, the storage 140 can perform a function for temporarily store image, voice, or data signals outputted from the external device interface 135 or the network interface 133 and can store information on a predetermined image through a channel memory function.

The storage 140 can store an application or an application list inputted from the external device interface 135 or the network interface 133.

The display device 100 can play content files (for example, video files, still image files, music files, document files, application files, and so on) stored in the storage 140 and provide them to a user.

The user input interface 150 can deliver signals inputted from a user to the controller 170 or deliver signals from the controller 170 to a user. For example, the user input interface 150 can receive or process control signals such as power on/off, channel selection, and screen setting from the remote control device 200 or transmit control signals from the controller 170 to the remote control device 200 according to various communication methods such as Bluetooth, Ultra Wideband (WB), ZigBee, Radio Frequency (RF), and IR.

Additionally, the user input interface 150 can deliver, to the controller 170, control signals inputted from local keys (not shown) such as a power key, a channel key, a volume key, and a setting key.

Image signals that are image-processed in the controller 170 can be inputted to the display 180 and displayed as an image corresponding to corresponding image signals. Additionally, image signals that are image-processed in the controller 170 can be inputted to an external output device through the external device interface 135.

Voice signals processed in the controller 170 can be outputted to the audio output interface 185. Additionally, voice signals processed in the controller 170 can be inputted to an external output device through the external device interface 135.

Besides that, the controller 170 can control overall operations in the display device 100.

Additionally, the controller 170 can control the display device 100 by a user command or internal program inputted through the user input interface 150 and download a desired application or application list into the display device 100 in access to network.

The controller 170 can output channel information selected by a user together with processed image or voice signals through the display 180 or the audio output interface 185.

Additionally, according to an external device image playback command received through the user input interface 150, the controller 170 can output image signals or voice signals of an external device such as a camera or a camcorder, which are inputted through the external device interface 135, through the display 180 or the audio output interface 185.

Moreover, the controller 170 can control the display 180 to display images and control broadcast images inputted through the tuner 131, external input images inputted through the external device interface 135, images inputted through the network interface, or images stored in the storage 140 to be displayed on the display 180. In this case, an image displayed on the display 180 can be a still image or video and also can be a 2D image or a 3D image.

Additionally, the controller 170 can play content stored in the display device 100, received broadcast content, and external input content inputted from the outside, and the content can be in various formats such as broadcast images, external input images, audio files, still images, accessed web screens, and document files.

Moreover, the wireless communication interface 173 can perform a wired or wireless communication with an external electronic device. The wireless communication interface 173 can perform short-range communication with an external device. For this, the wireless communication interface 173 can support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication interface 173 can support wireless communication between the display device 100 and a wireless communication system, between the display device 100 and another display device 100, or between networks including the display device 100 and another display device 100 (or an external server) through wireless area networks. The wireless area networks can be wireless personal area networks.

Herein, the other display device 100 can be a mobile terminal such as a wearable device (for example, a smart watch, a smart glass, and a head mounted display (HMD)) or a smartphone, which is capable of exchanging data (or inter-working) with the display device 100. The wireless communication interface 173 can detect (or recognize) a communicable wearable device around the display device 100. Furthermore, if the detected wearable device is a device authenticated to communicate with the display device 100, the controller 170 can transmit at least part of data processed in the display device 100 to the wearable device through the wireless communication interface 173. Accordingly, a user of the wearable device can use the data processed in the display device 100 through the wearable device.

The display 180 can convert image signals, data signals, or OSD signals, which are processed in the controller 170, or images signals or data signals, which are received in the external device interface 135, into R, G, and B signals to generate driving signals.

Furthermore, the display device 100 shown in FIG. 2 is just one embodiment of the present disclosure and thus, some of the components shown can be integrated, added, or omitted according to the specification of the actually implemented display device 100.

That is, if necessary, two or more components can be integrated into one component or one component can be divided into two or more components and configured. Additionally, a function performed by each block is to describe an embodiment of the present disclosure and its specific operation or device does not limit the scope of the present disclosure.

According to another embodiment of the present disclosure, unlike FIG. 2, the display device 100 can receive images through the network interface 133 or the external device interface 135 and play them without including the tuner 131 and the demodulator 132.

For example, the display device 100 can be divided into an image processing device such as a set-top box for receiving broadcast signals or contents according to various network services and a content playback device for playing contents inputted from the image processing device.

In this case, an operating method of a display device according to an embodiment of the present disclosure described below can be performed by one of the display device described with reference to FIG. 1, an image processing device such as the separated set-top box, and a content playback device including the display 180 and the audio output interface 185.

The audio output interface 185 receives the audio processed signal from the controller 170 and outputs the sound.

The power supply 190 supplies the corresponding power throughout the display device 100. In particular, the power supply 190 supplies power to the controller 170 that can be implemented in the form of a System On Chip (SOC), a display 180 for displaying an image, and the audio output interface 185 for outputting audio or the like.

Specifically, the power supply 190 may include a converter for converting an AC power source into a DC power source, and a DC/DC converter for converting a level of the DC source power.

The remote controller 200 transmits a user input to the user input interface 150. To do this, the remote controller 200 employs Bluetooth, radio frequency (RF) communication, infrared (IR) communication, ultra-wideband (UWB), a ZigBee specification, and so on. In addition, the remote controller 200 receives an image signal, an audio signal, or a data signal output from the user input interface 150, and displays the received signal on a display unit of the remote controller 200 or outputs the received signal, as audio, to an output unit of the remote controller 200.

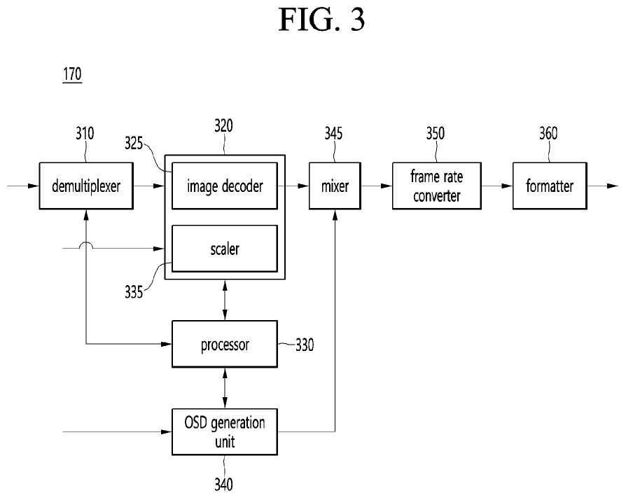

FIG. 3 is an example of a block diagram of the inside of a controller in FIG. 2.

For description with reference to the drawings, the controller 170 according to an embodiment of the present invention includes a demultiplexer 310, an image processing unit 320, a processor 330, an OSD generation unit 340, a mixer 345, a frame rate converter 350, and a formatter 360. In addition, an audio processing unit (not illustrated) and a data processing unit (not illustrated) are further included.

The demultiplexer 310 demultiplexes a stream input. For example, in a case where an MPEG-2 TS is input, the MPEG-2 TS is demultiplexed into an image signal, an audio signal, and a data signal. At this point, a stream signal input into the demultiplexer 310 is a stream signal output from the tuner 131, the demodulator 132, or the external device interface 135.

The image processing unit 320 performs image processing of the image signal that results from the demultiplexing. To do this, the image processing unit 320 includes an image decoder 325 or a scaler 335.

The image decoder 325 decodes the image signal that results from the demultiplexing. The scaler 335 performs scaling in such a manner that a resolution of an image signal which results from the decoding is such that the image signal is possibly output to the display 180.

Examples of the image decoder 325 possibly include decoders in compliance with various specifications. For example, the examples of the image decoder 325 include a decoder for MPEG-2, a decoder for H.264, a 3D image decoder for a color image and a depth image, a decoder for a multi-point image, and so on.

The processor 330 controls an overall operation within the display device 100 or within the controller 170. For example, the processor 330 controls the tuner unit 110 in such a manner that the tuner unit 110 performs the selection of (tuning to) the RF broadcast that corresponds to the channel selected by the user or the channel already stored.

In addition, the processor 330 controls the display device 100 using the user command input through the user input interface 150, or the internal program.

In addition, the processor 330 performs control of transfer of data to and from the network interface 133 or the external device interface 135.

In addition, the processor 330 controls operation of each of the demultiplexer 310, the image processing unit 320, the OSD generation unit 340, and so on within the controller 170.

The OSD generation unit 340 generates an OSD signal, according to the user input or by itself. For example, based on the user input signal, a signal is generated for displaying various pieces of information in a graphic or text format on a screen of the display 180. The OSD signal generated includes various pieces of data for a user interface screen of the display device 100, various menu screens, a widget, an icon, and so on. In addition, the OSD generated signal includes a 2D object or a 3D object.

In addition, based on a pointing signal input from the remote controller 200, the OSD generation unit 340 generates a pointer possibly displayed on the display. Particularly, the pointer is generated in a pointing signal processing unit, and an OSD generation unit 340 includes the pointing signal processing unit (not illustrated). Of course, it is also possible that instead of being providing within the OSD generation unit 340, the pointing signal processing unit (not illustrated) is provided separately.

The mixer 345 mixes the OSD signal generated in the OSD generation unit 340, and the image signal that results from the image processing and the decoding in the image processing unit 320. An image signal that results from the mixing is provided to the frame rate converter 350.

The frame rate converter (FRC) 350 converts a frame rate of an image input. On the other hand, it is also possible that the frame rate converter 350 outputs the image, as is, without separately converting the frame rate thereof.

On the other hand, the formatter 360 converts a format of the image signal input, into a format for an image signal to be displayed on the display, and outputs an image that results from the conversion of the format thereof.

The formatter 360 changes the format of the image signal. For example, a format of a 3D image signal is changed to any one of the following various 3D formats: a side-by-side format, a top and down format, a frame sequential format, an interlaced format, and a checker box format.

On the other hand, the audio processing unit (not illustrated) within the controller 170 performs audio processing of an audio signal that results from the demultiplexing. To do this, the audio processing unit (not illustrated) includes various decoders.

In addition, the audio processing unit (not illustrated) within the controller 170 performs processing for base, treble, volume adjustment and so on.

The data processing unit (not illustrated) within the controller 170 performs data processing of a data signal that results from the demultiplexing. For example, in a case where a data signal that results from the demultiplexing is a data signal the results from coding, the data signal is decoded. The data signal that results from the coding is an electronic program guide that includes pieces of broadcast information, such as a starting time and an ending time for a broadcast program that will be telecast in each channel.

On the other hand, a block diagram of the controller 170 illustrated in FIG. 3 is a block diagram for an embodiment of the present invention. Each constituent element in the block diagram is subject to integration, addition, or omission according to specifications of the image display controller 170 actually realized.

Particularly, the frame rate converter 350 and the formatter 360 may be provided separately independently of each other or may be separately provided as one module, without being provided within the controller 170.

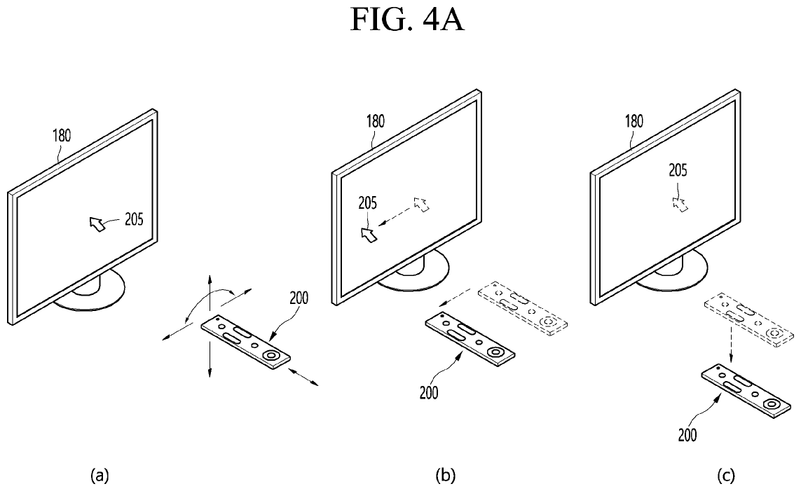

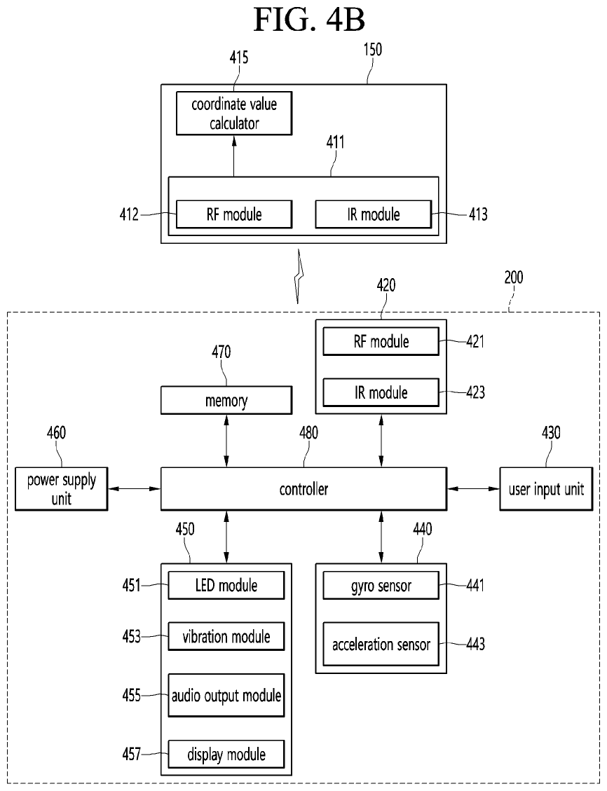

FIG. 4A is a diagram illustrating a method in which the remote controller in FIG. 2 performs control.

In FIG. 4A(a), it is illustrated that a pointer 205 which corresponds to the remote controller 200 is displayed on the display 180.

The user moves or rotates the remote controller 200 upward and downward, leftward and rightward (FIG. 4A(b)), and forward and backward (FIG. 4A(c)). The pointer 205 displayed on the display 180 of the display device corresponds to movement of the remote controller 200. As in the drawings, movement of the pointer 205, which depends on the movement of the remote controller 200 in a 3D space, is displayed and thus, the remote controller 200 is named a spatial remote controller or a 3D pointing device.

FIG. 4A(b) illustrates that, when the user moves the remote controller 200 leftward, the pointer 205 displayed on the display 180 of the display device correspondingly moves leftward.

Information on the movement of the remote controller 200, which is detected through a sensor of the remote controller 200, is transferred to the display device. The display device calculates the information on the movement of the remote controller 200 from coordinates of the pointer 205. The display device displays the pointer 205 in such a manner that the pointer 25 corresponds to the calculated coordinates.

FIG. 4A(c) illustrates a case where the user moves the remote controller 200 away from the display 180 in a state where a specific button within the remote controller 200 is held down. Accordingly, a selection area within the display 180, which corresponds to the pointer 205, is zoomed in so that the selection area is displayed in an enlarged manner. Conversely, in a case where the user causes the remote controller 200 to approach the display 180, the selection area within the display 180, which corresponds to the pointer 205, is zoomed out so that the selection is displayed in a reduced manner. On the other hand, in a case where the remote controller 200 moves away from the display 180, the selection area may be zoomed out, and in a case where the remote controller 200 approaches the display 180, the selection area may be zoomed in.

On the other hand, an upward or downward movement, or a leftward or rightward movement is not recognized in a state where a specific button within the remote controller 200 is held down. That is, in a case where the remote controller 200 moves away from or approaches the display 180, only a forward or backward movement is set to be recognized without the upward or downward movement, or the leftward or rightward movement being recognized. Only the pointer 205 moves as the remote controller 200 moves upward, downward, leftward, or rightward, in a state where a specific button within the remote controller 200 is not held down.

On the other hand, a moving speed or a moving direction of the pointer 205 corresponds to a moving speed or a moving direction of the remote controller 200, respectively.

FIG. 4B is a block diagram of the inside of the remote controller in FIG. 2.

For description with reference to the drawings, the remote controller 200 includes a wireless communication unit 420, a user input unit 430, a sensor unit 440, an output unit 450, a power supply unit 460, a memory 470, and a controller 480.

The wireless communication unit 420 transmits and receives a signal to and from an arbitrary one of the display devices according to the embodiments of the present invention, which are described above. Of the display devices according to the embodiments of the present invention, one display device is taken as an example for description.

According to the present embodiment, the remote controller 200 includes an RF module 421 that transmits and receives a signal to and from the display device 100 in compliance with RF communication standards. In addition, the remote controller 200 includes an IR module 423 that possibly transmits and receives a signal to and from the display device 100 in compliance with IR communication standards.

According to the present embodiment, the remote controller 200 transfers a signal containing information on the movement of the remote controller 200 to the display device 100 through the RF module 421.

In addition, the remote controller 200 receives a signal transferred by the display device 100, through the RF module 421. In addition, the remote controller 200 transfers a command relating to power-on, power-off, a channel change, or a volume change, to the display device 100, through the IR module 423, whenever needed.

The user input unit 430 is configured with a keypad, buttons, a touch pad, a touch screen, or so on. The user inputs a command associated with the display device 100 into the remote controller 200 by operating the user input unit 430. In a case where the user input unit 430 is equipped with a physical button, the user inputs the command associated with the display device 100 into the remote controller 200 by performing an operation of pushing down the physical button. In a case where the user input unit 430 is equipped with a touch screen, the user inputs the command associated with the display device 100 into the remote controller 200 by touching on a virtual key of the touch screen. In addition, the user input unit 430 may be equipped with various types of input means operated by the user, such as a scroll key or a jog key, and the present embodiment does not impose any limitation on the scope of the present invention.

The sensor unit 440 includes a gyro sensor 441 or an acceleration sensor 443. The gyro sensor 441 senses information on the movement of the remote controller 200.

As an example, the gyro sensor 441 senses the information on operation of the remote controller 200 on the x-, y-, and z-axis basis. The acceleration sensor 443 senses information on the moving speed and so on of the remote controller 200. On the other hand, a distance measurement sensor is further included. Accordingly, a distance to the display 180 is sensed.

The output unit 450 outputs an image or an audio signal that corresponds to the operating of the user input unit 430 or corresponds to a signal transferred by the display device 100. Through the output unit 450, the user recognizes whether or not the user input unit 430 is operated or whether or not the display device 100 is controlled.

As an example, the output unit 450 includes an LED module 451, a vibration module 453, an audio output module 455, or a display module 457. The LED module 451, the vibration module 453, the audio output module 455, and the display module 457 emits light, generates vibration, outputs audio, or outputs an image, respectively, when the input unit 435 is operated, or a signal is transmitted and received to and from the display device 100 through a wireless communication unit 420.

The power supply unit 460 supplies a power to the remote controller 200. In a case where the remote controller 200 does not move for a predetermined time, the power supply unit 460 reduces power consumption by interrupting power supply. In a case where a predetermined key provided on the remote controller 200 is operated, the power supply unit 460 resumes the power supply.

Various types of programs, pieces of application data, and so on that are necessary for control or operation of the remote controller 200 are stored in the memory 470. In a case where the remote controller 200 transmits and receives a signal to and from the display device 100 in a wireless manner through the RF module 421, the signal is transmitted and received in a predetermined frequency band between the remote controller 200 and the display device 100. The controller 480 of the remote controller 200 stores information on, for example, a frequency band in which data is transmitted and received in a wireless manner to and from the display device 100 paired with the remote controller 200, in the memory 470, and makes a reference to the stored information.

The controller 480 controls all operations associated with the control by the remote controller 200. The controller 480 transfers a signal that corresponds to operating of a predetermined key of the user input unit 430, or a signal that corresponds to the movement of the remote controller 200, which is sensed in the sensor unit 440, to the display device 100 through the wireless communication unit 420.

A user input interface 150 of the display device 100 includes a wireless communication unit 411 that transmits and receives a signal in a wireless manner to and from the remote controller 200, and a coordinate value calculator 415 that calculates a coordinate value of the pointer, which corresponds to the operation of the remote controller 200.

The user input interface 150 transmits and receives the signal in a wireless manner to and from the remote controller 200 through the RF module 412. In addition, a signal transferred in compliance with the IR communication standards by the remote controller 200 through the IR module 413 is received.

The coordinate value calculator 415 calculates a coordinate value (x, y) of the pointer 205 to be displayed on the display 180, which results from compensating for a hand movement or an error, from a signal that corresponds to the operation of the remote controller 200, which is received through the wireless communication unit 411.

A transfer signal of the remote controller 200, which is input into the display device 100 through the user input interface 150 is transferred to the controller 170 of the display device 100. The controller 170 determines information on the operation of the remote controller 200 and information on operating of a key, from the signal transferred by the remote controller 200, and correspondingly controls the display device 100.

As another example, the remote controller 200 calculates a coordinate value of a pointer, which corresponds to the operation of the remote controller 200, and outputs the calculated value to the user input interface 150 of the display device 100. In this case, the user input interface 150 of the display device 100 transfers information on the received coordinate values of the pointer, to the controller 170, without performing a process of compensating for the hand movement and the error.

In addition, as another example, unlike in the drawings, it is also possible that the coordinate value calculator 415 is included within the controller 170 instead of the user input interface 150.

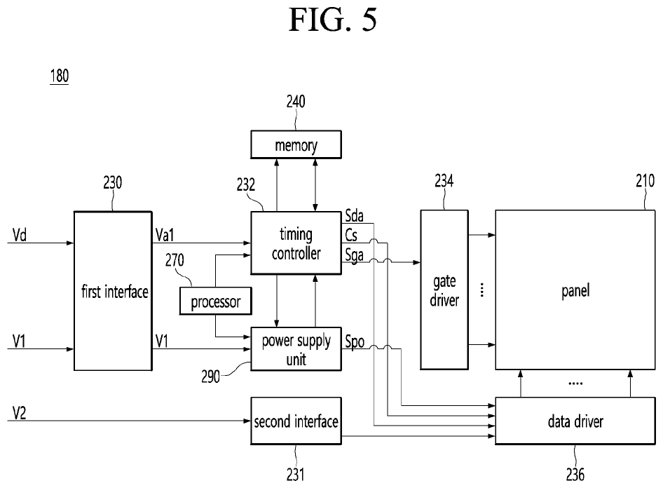

FIG. 5 is a block diagram of the inside of the display in FIG. 2.

With reference with the drawings, the display 180 based on the organic light-emitting diode may include the OLED panel 210, a first interface 230, a second interface 231, a timing controller 232, a gate driver 234, a data driver 236, a memory 240, a processor 270, a power supply unit 290, and so on.

The display 180 receives an image signal Vd, a first direct current power V1, and a second direct current power V2. Based on the image signal Vd, the display 180 display a predetermined image is displayed.

On the other hand, the first interface 230 within the display 180 receives the image signal Vd and the first direct current power V1 from the controller 170.

At this point, the first direct current power V1 is used for operation for each of the power supply unit 290 and the timing controller 232 within the display 180.

Next, the second interface 231 receives the second direct current power V2 from the external power supply unit 190. On the other hand, the second direct current power V2 is input into the data driver 236 within the display 180.

Based on the image signal Vd, the timing controller 232 outputs a data drive signal Sda and a gate drive signal Sga.

For example, in a case where the first interface 230 converts the image signal Vd input, and outputs image signal val that results from the conversion, the timing controller 232 outputs the data drive signal Sda and the gate drive signal Sga based on the image signal val that results from the conversion.

The timing controller 232 further receives a control signal, the vertical synchronization signal Vsync, and so on, in addition to a video signal Vd from the controller 170.

The timing controller 232 outputs the gate drive signal Sga for operation of the gate driver 234 and the data drive signal Sda for operation of the data driver 236, based on the control signal, the vertical synchronization signal Vsync, and so on in addition to the video signal Vd.

In a case where the OLED panel 210 includes a subpixel for RGBW, the data drive signal Sda at this time is a data drive signal for a subpixel for RGBW.

On the other hand, the timing controller 232 further outputs a control signal Cs to the gate driver 234.

The gate driver 234 and the data driver 236 supplies a scanning signal and an image signal to the OLED panel 210 through a gate line GL and a data line DL according to the gate drive signal Sga and the data drive signal Sda, respectively, from the timing controller 232. Accordingly, a predetermined image is displayed on the OLED panel 210.

On the other hand, the OLED panel 210 includes an organic light-emitting layer. In order to display an image, many gate lines GL and many data lines DL are arranged to intersect each other in a matrix form, at each pixel that corresponds to the organic light-emitting layer.

On the other hand, the data driver 236 outputs a data signal to the OLED panel 210 based on the second direct current power V2 from the second interface 231.

The power supply unit 290 supplies various types of powers to the gate driver 234, the data driver 236, the timing controller 232, and so on.

The processor 270 performs various types of control within the display 180. For example, the gate driver 234, the data driver 236, the timing controller 232, and so on are controlled.

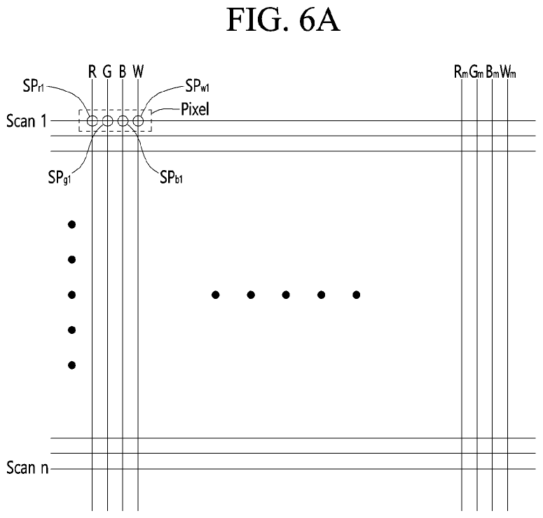

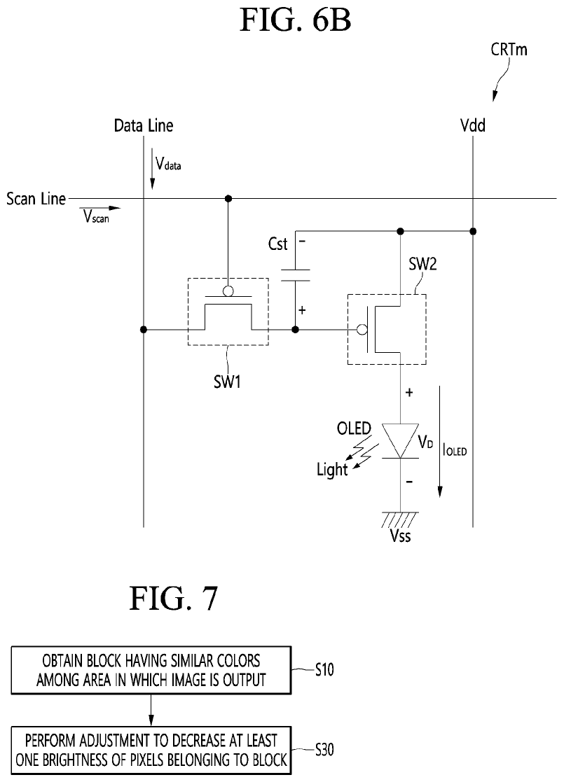

FIGS. 6A and 6B are diagrams that are referred to for description of the OLED panel in FIG. 5.

First, FIG. 6A is a diagram illustrating a pixel within the OLED panel 210.

With reference to the drawings, the OLED panel 210 includes a plurality of scan lines Scan 1 to Scan n and a plurality of data lines R1, G1, B1, W1 to Rm, Gm, Bm, Wm that intersect a plurality of scan lines Scan 1 to Scan n, respectively.

On the other hand, an area where the scan line and the data line within the OLED panel 210 intersect each other is defined as a subpixel. In the drawings, a pixel that includes a subpixel SPr1, SPg1, SPb1, SPw1 for RGBW is illustrated.

In FIG. 6A, although it is illustrated that the RGBW sub-pixels are provided in one pixel, RGB subpixels may be provided in one pixel. That is, it is not limited to the pixel element arrangement method of a pixel.

FIG. 6B illustrates a circuit of one subpixel within the OLED panel in FIG. 6A.

With reference to the drawings, an organic light-emitting subpixel circuit CRTm includes a switching element SW1, a storage capacitor Cst, a drive switching element SW2, and an organic light-emitting layer (OLED), which are active-type elements.

A scan line is connected to a gate terminal of the scan switching element SW1. The scanning switching element SW1 is turned on according to a scan signal Vscan input. In a case where the scan switching element SW1 is turned on, a data signal Vdata input is transferred to the gate terminal of the scan switching element SW2 or one terminal of the storage capacitor Cst.

The storage capacitor Cst is formed between the gate terminal and a source terminal of the drive switching element SW2. A predetermined difference between a data signal level transferred to one terminal of the storage capacitor Cst and a direct current (Vdd) level transferred to the other terminal of the storage capacitor Cst is stored in the storage capacitor Cst.

For example, in a case where data signals have different levels according to a pulse amplitude modulation (PAM) scheme, power levels that are stored in the storage capacitor Cst are different according to a difference between levels of data signals Vdata.

As another example, in a case where data signals have different pulse widths according to a pulse width modulation (PWM) scheme, power levels that are stored in the storage capacitor Cst are different according to a difference between pulse widths of data signals Vdata.

The drive switching element SW2 is turned on according to the power level stored in the storage capacitor Cst. In a case where the drive switching element SW2 is turned on, a drive electric current (IOLED), which is in proportion to the stored power level, flows through the organic light-emitting layer (OLED). Accordingly, the organic light-emitting layer (OLED) performs a light-emitting operation.

The organic light-emitting layer (OLED) includes a light-emitting layer (EML) for RGBW, which corresponds to a subpixel, and includes at least one of the following layers: a hole implementation layer (HIL), a hole transportation layer (HTL), an electron transportation layer (ETL), and an electron implementation layer (EIL). In addition to these, the organic light-emitting layer includes a hole support layer and so on.

On the other hand, when it comes to a subpixel, the organic light-emitting layer outputs while light, but in the case of the subpixels for green, red, and blue, a separate color filter is provided in order to realize color. That is, in the case of the subpixels for green, red, and blue, color filters for green, red, and blue, respectively, are further provided. On the other hand, in the case of the subpixel for white, white light is output and thus a separate color filter is unnecessary.

On the other hand, in the drawings, as the scan switching element SW1 and the drive switching element SW2, p-type MOSFETs are illustrated, but it is also possible that n-type MOSFETs, or switching elements, such as JETs, IGBTs, or SICs, are used.

Meanwhile, such a pixel may be burned-in when continuously outputting the same color. Accordingly, a display device 100 according to an embodiment of the present disclosure aims to minimize a phenomenon in which pixels are burned in while maintaining the brightness of an image. The display 180 may include a plurality of pixels, and the controller 170 may control a plurality of pixels according to pixel data of an input image. In this case, the controller 170 may obtain a block having similar colors among an area in which an image is output by the display 180, and perform adjustment to decrease the brightness of at least one of the pixels belonging to the block, thereby minimizing the burn-in phenomenon of the pixel while maintaining the brightness.

FIG. 7 is a flowchart for a method for operating a display device according to a first embodiment of the present disclosure.

The controller 170 may obtain a block having similar colors among the area in which an image is output (S10).

Each of the plurality of pixels provided in the panel 210 may be controlled according to an image signal.

The image signal may include pixel data of pixels for each of a plurality of frames, that is, RGB data or WRGB data. Hereinafter, it is assumed that the image signal includes WRGB data for each of a plurality of frames, but this is only exemplary and is not limited thereto.

The controller 170 may obtain a block by extracting pixels whose a difference between pixel data is less than or equal to a preset reference value. The controller 170 may obtain a block having similar colors based on pixel data for each frame.

As a specific example, the controller 170 may extract whether pixels express similar colors based on WRGB data of each frame.

Similar colors may represent the same color or analogous colors.

When a difference between the pixel data of a first pixel and the pixel data of a second pixel is less than or equal to a preset reference value, the controller 170 may recognize the first pixel and the second pixel as having similar colors. In this case, the second pixel may be a pixel adjacent to the first pixel.

Specifically, as the difference between the WRGB data of the first pixel and the WRGB data of the second pixel is smaller, the controller 170 may determine that the first pixel and the second pixel express similar colors.

For example, the image signal may include data of each of a W subpixel, an R subpixel, a G subpixel, and a B subpixel for each frame, and each of the W subpixel, R subpixel, G subpixel and B subpixel may have a value between 0 and 255.

As an example, the controller 170 may determine that the first pixel and the second subpixel have similar colors when each of a difference between the W subpixel of the first pixel and the W subpixel of the second pixel, a difference between the R subpixel of the first pixel and the R subpixel of the second pixel, a difference between the G subpixel of the first pixel and the G subpixel of the second pixel, and a difference between the B subpixel of the first pixel and the B subpixel of the second pixel is less than or equal to a preset reference value.

The controller 170 may obtain a block having similar colors by comparing WRGB data of pixels for each frame.

A block having similar colors may be a set of pixels having similar colors.

Since the controller 170 obtains a block having similar colors for each frame, the block having similar colors may be changed when a frame is changed. The controller 170 may change a position of a block, a size of a block, or the number of blocks according to frames. That is, the positions, areas, and numbers of blocks each having similar colors may be different for each frame.

The controller 170 may not be able to obtain a block in one frame. In addition, the controller 170 may obtain one or more blocks in one frame.

In addition, the controller 170 may obtain a block having similar colors by comparing WRGB data of adjacent pixels.

According to an embodiment, when comparing WRGB data of pixels, the controller 170 may compare a first pixel with pixels located above, below, left, and right of the first pixel to obtain a block of similar colors.

According to another embodiment, when comparing WRGB data of pixels, the controller 170 may obtain a block having similar colors by comparing the first pixel with pixels located within a predetermined distance from the first pixel.

In this way, since the controller 170 compares WRGB data of adjacent pixels when obtaining a block having similar colors, each block may be a set of consecutive pixels.

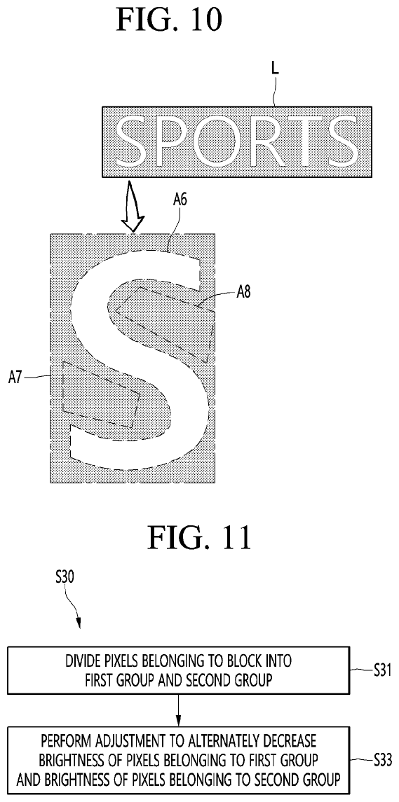

The block having similar colors will be described in more detail with reference to FIGS. 9 to 10.

The controller 170 may perform adjustment to decrease a brightness of at least one of pixels belonging to a block (S30).

When the controller 170 obtains at least one block having similar colors, pixels belonging to the block may be made of similar colors. Accordingly, the controller 170 may perform adjustment to adjust the brightness of at least one of the pixels belonging to the block to be lower than a brightness according to the image signal. In this case, the lifespan reduction speed of a pixel having a lower brightness may be reduced. In this case, as adjacent pixels are output brightly according to an image signal, the brightness perceived by the user may be maintained.

That is, the controller 170 may perform adjustment to decrease the brightness of at least one of the pixels belonging to the block and output at least another brightness according to the image signal.

In this case, the controller 170 may periodically change a pixel whose a brightness is adjusted to be low among pixels belonging to the block.

On the other hand, the amount of reduction in brightness may be set in advance with a set ratio, a set value, or the like. For example, the controller 170 may decrease a pixel value of a pixel whose brightness is to be controlled to be lower by the set ratio than data of a pixel according to an image signal. For example, when the pixel data of the image signal is (0, 100, 100, 0) and a ratio set to decrease brightness is 10%, the controller 170 may decrease the brightness of some pixels by controlling the pixel value of the pixel to (0, 90, 90, 0).

However, this is only exemplary, and the controller 170 may perform adjustment to decrease the brightness of some of the pixels in the block in various methods.

Meanwhile, there may be various methods in which the controller 170 perform adjustment to decrease the brightness of at least one of the pixels belonging to the block.

For example, according to an embodiment, the controller 170 may extract an arbitrary pixel from among pixels belonging to a block and then perform adjustment to decrease the brightness of the extracted pixel.

According to another embodiment, the controller 170 may extract a pixel whose remaining life is less than or equal to a preset reference time among pixels belonging to the block and then perform adjustment to decrease the brightness of the extracted pixel.

According to another embodiment, the controller 170 may classify pixels belonging to a block into a first group and a second group, and then perform adjustment to alternately decrease the brightness of the pixels belonging to the first group and the brightness of the pixels belonging to the second group. Details will be described with reference to FIGS. 11 to 13.

According to the first embodiment of the present disclosure, there is an advantage of minimizing a reduction in lifetime of pixels while maintaining the brightness of an output image.

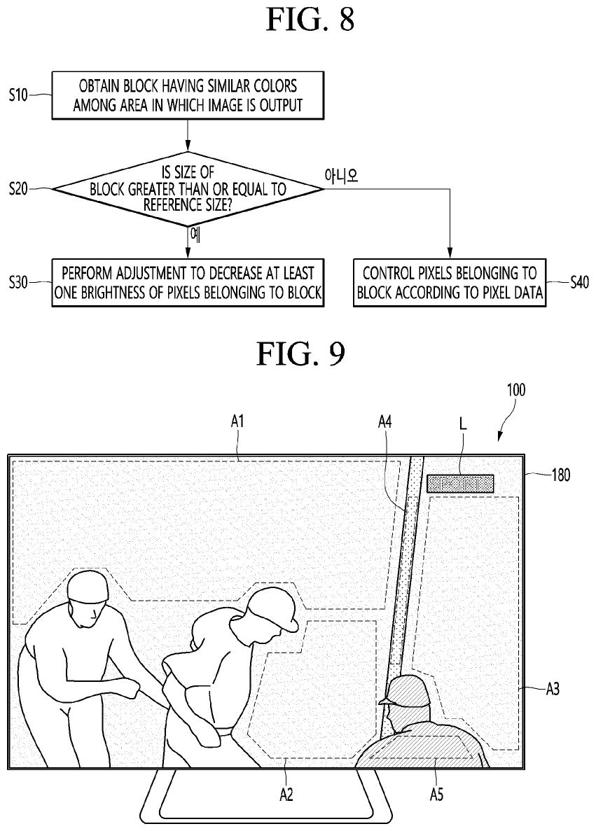

FIG. 8 is a flowchart for a method for operating a display device according to a second embodiment of the present disclosure.

The controller 170 may obtain a block having similar colors among the area in which an image is output (S10).

This is the same as that described with reference to step S10 of FIG. 7, and therefore, a redundant description will be omitted.

The controller 170 may determine whether a size of the block is greater than or equal to a reference size (S20).

That is, the controller 170 may obtain whether the size of the block is greater than or equal to the reference size.

According to an embodiment, the controller 170 may obtain the size of the block based on the number of pixels belonging to the block. Accordingly, the controller 170 may determine whether the size of the block is greater than or equal to the reference size based on the number of pixels belonging to the block. For example, when the number of pixels belonging to the block is 100 or more, the controller 170 may determine that the size of the block is greater than or equal to the reference size. However, 100 are merely examples for convenience of description, and various reference sizes may be provided. For example, the controller 170 may set the number of reference sizes differently according to a size of the screen.

When the size of the block is greater than or equal to the reference size, the controller 170 may perform adjustment to decrease a brightness of at least one of pixels belonging to a block (S30).

That is, when the size of the block is greater than or equal to the reference size, the controller 170 may perform adjustment to decrease a brightness of at least one of pixels belonging to a block.

A method for performing adjustment to decrease a brightness of at least one of pixels belonging to a block is the same as described in step S30 of FIG. 7, and therefore, a redundant description will be omitted.

On the other hand, when the size of the block is less than the reference size, the controller 170 may control pixels belonging to the block according to pixel data (S40).

That is, when the size of the block is less than the reference size, the controller 170 may perform control according to pixel data received as an image signal without separately decreasing the brightness of pixels belonging to the block.

When a size of the block is too small, a user is more likely to perceive a decrease in brightness of pixels although the brightness of some pixels is decreased, so that it is possible to prevent the user to perceive the decrease in brightness by controlling the brightness only for blocks larger than the reference size.

FIGS. 9 to 10 are exemplary diagrams for describing a method for obtaining a block having similar colors in a display device according to an embodiment of the present disclosure.

The controller 170 may obtain a block having similar colors among the area in which an image is output. Referring to the example of FIG. 9, the controller 170 may obtain, as a block having similar colors, a first block A1, a second block A2, a third block A3, a fourth block A4, and a fifth block A5.

The WRGB data of pixels belonging to the first block A1 may be similar, the WRGB data of pixels belonging to the second block A2 may be similar, and the WRGB data of pixels belonging to the third block A3 may be similar, the WRGB data of pixels belonging to the fourth block A4 may be similar, and the WRGB data of the pixels belonging to the fifth block A5 may be similar.

In addition, the controller 170 may obtain a block having similar colors not only from a video image but also from a GUI such as an OSD.

For example, a logo area L shown in FIG. 9 may be a GUI. The controller 170 may also obtain a block having similar colors in the GUI.

FIG. 10 may be the logo area L of a screen shown in FIG. 9 and an enlarged image of a part of the logo area L. The controller 170 may obtain a sixth block A6, a seventh block A7, and an eighth block A8 as blocks having similar colors by comparing WRGB data of pixels in the logo area L.

The block obtained by the controller 170 may be a stationary area or an area expressed only in one color. Alternatively, the block obtained by the controller 170 may be an area displaying the same or similar colors.

Meanwhile, blocks having similar colors illustrated in FIGS. 9 to 10 are provided as examples for convenience of description and are not limited thereto.

As shown in FIGS. 9 to 10, blocks having similar colors which are obtained by the controller 170 may have various sizes and shapes. In addition, FIGS. 9 to 10 are examples of blocks obtained for one frame, and a block may be changed as a frame is changed.

FIG. 11 is a flowchart for an embodiment of a method for lowering a brightness of at least one of pixels belonging to a block in a display device according to an embodiment of the present disclosure.

The controller 170 may divide pixels belonging to a block into a first group and a second group (S31), and perform adjustment to alternately decrease the brightness of the pixels belonging to the first group and the brightness of the pixels belonging to the second group (S33).

That is, the controller 170 may divide the pixels belonging to the block into the first group and the second group, and perform adjustment to decrease the brightness of any one of the first group and the second group.

First, a method for dividing pixels belonging to a block into a first group and a second group will be described.

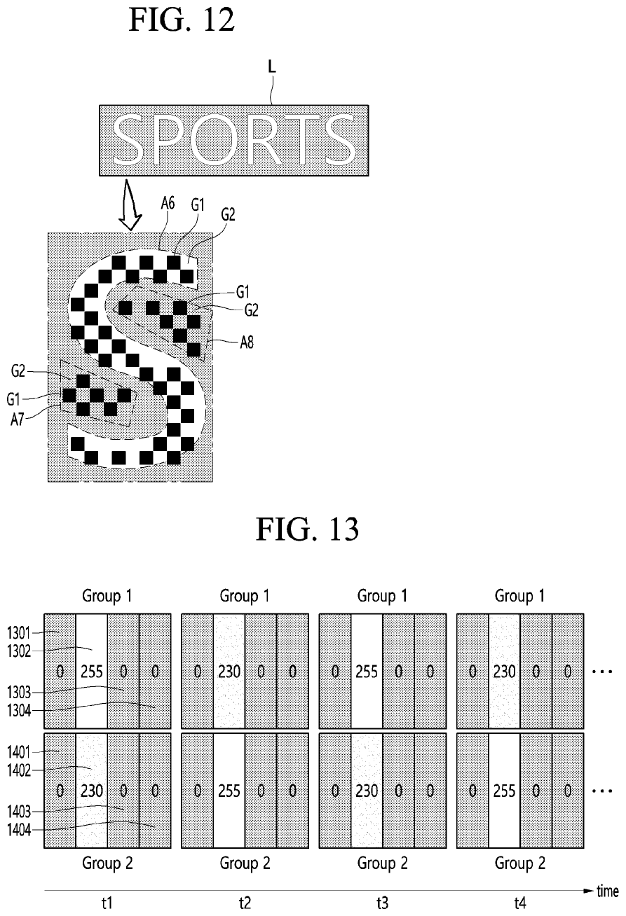

According to an embodiment, the controller 170 may divide pixels belonging to a block into a first group and a second group such that pixels belonging to the first group and pixels belonging to the second group are alternately arranged. Details will be described in more detail with reference to FIG. 12.

FIG. 12 is an exemplary diagram showing a method for dividing pixels belonging to a specific block into a first group and a second group in a display device according to an embodiment of the present disclosure.

As shown in FIG. 12, the controller 170 may divide pixels of the sixth block A6 into the pixels belonging to the first group G1 (shown in black) and the pixels belonging to the second group G2 (Shown in white). Similarly, the controller 170 may divide pixels belonging to the seventh block A7 into the pixels belonging to the first group G1 (shown in black) and the pixels belonging to the second group G2 (shown in gray). The controller 170 may divide pixels belonging to the eighth block A8 into the pixels belonging to the first group G1 (shown in black) and the pixels belonging to the second group G2 (shown in gray).

That is, the controller 170 may set pixels adjacent to the pixels belonging to the first group as the second group, and pixels adjacent to the pixels belonging to the second group as the first group.

The controller 170 may divide the pixels in the block into a first group and a second group such that the first group and the second group form a checkered pattern.

Accordingly, the pixels belonging to the first group and the pixels belonging to the second group are alternately arranged. In this case, even when the brightness of the pixels belonging to the first group is lower than a brightness according to the image signal, it may be difficult for the user to recognize the decrease in brightness of the corresponding block due to the brightness of the pixels belonging to the second group. Likewise, even when the brightness of the pixels belonging to the second group is lower than a brightness according to the image signal, it may be difficult for the user to recognize the decrease in brightness of the corresponding block due to the brightness of the pixels belonging to the first group.

FIG. 13 is an exemplary diagram for describing a method for controlling the brightness of pixels belonging to a first group and pixels belonging to a second group in a display device according to an embodiment of the present disclosure.

The controller 170 may perform adjustment to alternately decrease the brightness of the pixels belonging to the first group and the brightness of the pixels belonging to the second group. Specifically, the controller 170 repeatedly perform the first mode and the second mode at set periods. In the first mode, the pixels belonging to the first group are driven according to pixel data, and the pixels belonging to the second group are driven with a brightness lower than that of the pixel data and in the second mode, the pixels belonging to the second group are driven according to pixel data, and the pixels belonging to the first group are driven with a brightness lower than that of the pixel data.

Referring to the example illustrated in FIG. 12, the controller 170 may obtain (0, 255, 0, 0) as WRGB data of pixels belonging to a specific block. In this case, the controller 170 may divide the pixels of a corresponding block into a first group (Group 1) and a second group (Group 2), and then control one of pixels belonging to the first group with (0, 255, 0, 0) and another pixel with (0, 230, 0, 0).

Specifically, the controller 170 may operate in the first mode at a time point t1to control W subpixels 1301 with 0, R subpixels 1302 with 255, and G subpixel 1303 with 0, and B subpixels 1304 with 0 in the pixels belonging to the first group, and control W subpixels 1401 with 0, R subpixels 1402 with 230, G subpixels 1403 with 0, and B subpixels 1404 with 0 in the pixels belonging to the second group, thus performing adjustment to decrease the brightness of pixels belonging to the second group.

Further, the controller 170 may operate in the third mode at a time point t2 to control W subpixels 1301 with 0, R subpixels 1302 with 255, and G subpixel 1303 with 0, and B subpixels 1304 with 0 in the pixels belonging to the first group, and control W subpixels 1401 with 0, R subpixels 1402 with 230, G subpixels 1403 with 0, and B subpixels 1404 with 0 in the pixels belonging to the second group, thus performing adjustment to decrease the brightness of pixels belonging to the first group.

Similarly, the controller 170 may operate in the first mode at time point t3 to decrease the brightness of pixels belonging to the second group among the first group and operate in the second mode at time point t4 to decrease the brightness of pixels belonging to the first group among the first group and the second group.

That is, after dividing the pixels belonging to the block into the first group and the second group, the controller 170 may alternately change a group whose brightness is adjusted to be decreased among the first group and the second group.

As such, the controller 170 can maintain the brightness perceived by the user while minimizing the reduction in lifetime of the pixels by performing adjustment to alternately decrease the brightness of the pixels belonging to the first group and the brightness of the pixels belonging to the second group.

Meanwhile, according to an embodiment, unlike FIG. 13, the controller 170 may divide the pixels belonging to the block into the first group and the second group, and adjust the brightness of the first group to be lower than the brightness according to the image signal and adjust the brightness of the second group according to the brightness of the image signal.

Conversely, the controller 170 may divide the pixels belonging to the block into the first group and the second group, and adjust the brightness of the second group to be lower than the brightness according to the image signal and adjust the brightness of the first group according to the brightness of the image signal.

That is, according to an embodiment, the controller 170 may not change a group whose a brightness is adjusted to be decreased.

In the present disclosure, in particular, as the pixel becomes smaller, its effect can be maximized. Even through the brightness of some of pixels in a block having similar colors is controlled to be decreased, it is difficult for the user to recognize a reduction in brightness as the size of the pixel is smaller.

Meanwhile, the present disclosure can be applied not only to the display device 100 but also to a lighting.

The above description is merely illustrative of the technical idea of the present disclosure, and various modifications and changes may be made thereto by those skilled in the art without departing from the essential characteristics of the present disclosure.

Therefore, the embodiments of the present disclosure are not intended to limit the technical spirit of the present disclosure but to illustrate the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

1-15. (canceled)

16. A display device comprising:
a display including a plurality of pixels; and
a controller configured to:
receive input image data for displaying images via the plurality of pixels;
identify a block of pixels of the plurality of pixels outputting similar colors according to the input image data; and
perform adjustment to decrease a brightness of at least pixel of the pixels of the identified block.

17. The display device of claim 16, wherein the controller is further configured to identify the block of pixels outputting similar colors based on pixel data for each frame of the input image data.

18. The display device of claim 16, wherein the controller is further configured to recognize a first pixel and an adjacent second pixel of the plurality of pixels as outputting similar colors based on a difference between pixel data of the first pixel and pixel data of the second pixel being less than or equal to a preset reference value.

19. The display device of claim 16, wherein the controller is further configured to identify the block by determining differences in pixel data that are less than or equal to a preset reference value.

20. The display device of claim 16, wherein the controller is further configured to:
divide pixels of the identified block into a first group and a second group; and
perform adjustment to decrease brightness of pixels of the first group or the second group.

21. The display device of claim 20, wherein the pixels of the first group and pixels of the second group are alternately arranged.

22. The display device of claim 20, wherein the controller is further configured to perform adjustment to alternately decrease brightness of the pixels of the first group and brightness of the pixels of the second group.

23. The display device of claim 22, wherein the controller is further configured to alternate between performing a first mode and a second mode based on a set period of time,
wherein in the first mode the pixels of the first group are driven according to pixel data of the input image data, and the pixels of the second group are driven at a lower brightness than the pixel data of the input image data, and
wherein in the second mode the pixels of the second group are driven according to the pixel data of the input image data, and the pixels of the first group are driven at a lower brightness than the pixel data of the input image data.

24. The display device of claim 16, wherein the controller is further configured to perform adjustment to decrease the brightness of the at least one pixel based on a size of the block being greater than or equal to a reference size.

25. The display device of claim 24, wherein the controller is further configured to determine the size of the block based on the number of pixels belonging to the block.

26. The display device of claim 24, wherein brightness of the pixels of the block is not adjusted when the size of the block is less than the reference size.

27. The display device of claim 16, wherein the controller is further configured to identify a plurality of blocks in a single frame.

28. The display device of claim 16, wherein the controller is further configured to change a position of the block, a size of the block, or a number of identified blocks based on changes between frames of the input image data.

29. The display device of claim 16, wherein the controller is further configured to periodically select different pixels belonging to the block for adjusting brightness.

30. A method for operating a display device, comprising:
receiving input image data for displaying images via a plurality of pixels of the display device;
identifying a block of pixels of the plurality of pixels outputting similar colors according to the input image data; and
performing adjustment to decrease a brightness of at least one pixel of the pixels of the identified block.

31. The method of claim 30, wherein the block of pixels is identified based on pixel data for each frame of the input image data.

32. The method of claim 30, wherein identifying the block comprises recognizing a first pixel and an adjacent second pixel of the plurality of pixels as outputting similar colors based on a difference between pixel data of the first pixel and pixel data of the second pixel being less than or equal to a preset reference value.

33. The method of claim 30, further comprising:
dividing pixels of the identified block into a first group and a second group; and
performing adjustment to decrease brightness of pixels of the first group or the second group.

34. The method of claim 33, wherein the pixels of the first group and pixels of the second group are alternately arranged.

35. The method of claim 33, wherein performing the adjustment comprises alternately decreasing brightness of the pixels of the first group and brightness of the pixels of the second group.
